(19) United States
(12) Patent Application Publication
(10) Pub. No.: US 2021/0345749 A1
(43) Pub. Date: Nov. 11, 2021

(54) HAIR DYEING PROCESS

(71) Applicant: L'OREAL, Paris (FR)

(72) Inventors: Jean-Luc Robinault, Saint-Ouen (FR); Henri Samain, Chevilly LaRue (FR)

(21) Appl. No.: 17/281,047

(22) PCT Filed: Oct. 1, 2019
(86) PCT No.: PCT/EP2019/076624

§ 371 Date: Mar. 29, 2021

(30) Foreign Application Priority Data
Oct. 2, 2018 (FR) 1859110

(51) Int. Cl. A45D 19/02; A45D 34/04; A45D 19/00

(52) U.S. Cl. CPC A45D 19/022; A45D 19/0066; A45D 34/04; A45D 19/02

(57) ABSTRACT

A process for hair dyeing and/or bleaching, including applying, to the head of hair, at least one hair dyeing or bleaching compound using a device. The device including at least two nozzles, at least one of which is supplied with at least one pressurized liquid containing said compound, the nozzles being arranged such that their respective jets collide with one another.

### PRIOR ART

A dispensing device comprising two nozzles, the respective jets of which collide with one another, is already known and described in publication EP 1 954 893 B1 from Creaholic SA.

In the field of hair dyeing and bleaching intended to enhance the beauty of, or treat, the hair, there is a need to apply compositions and to bring them into contact with the hair.

For this purpose, it is common practice to apply a fluid then to spread it out. It is necessary to use tools such as combs and brushes or to apply it by hand. In many cases, there is a need to ensure homogeneous distribution over the whole of the head of hair, since an area which might have been forgotten will be quickly noticed, giving the overall head of hair an unattractive effect, the opposite of the desired effect.

This is also the case if a part of the head of hair received too much product compared to the rest of the head of hair, thereby producing unattractive non-uniform effects.

In the case of dyeing, the user goes as far as using a brush to treat each segment of hair, with the aim of ensuring that a layer of product is indeed covering each area. This technique also enables them to ensure that the application to each area is equivalent in terms of amount to the application to the previous areas.

It can therefore be seen that the known approaches can be classified into two categories:

a) application then use of a tool to spread the fluid from the area which received the application towards the rest of the head of hair; or

b) application area-by-area of an amount of fluid suited to each area.

In both cases, the user tends to apply a lot of product to prevent gaps.

Strangely, there is no solution which makes it possible to carry out homogeneous application, in the sense of neither a lack nor a surplus. Thus, users, such as hairdressers in particular, spend a lot of time on these application steps. Consequently, they have less time to carry out other tasks and are forced to bill for this time spent, making the operation particularly expensive.

The problem also arises in the other direction. Indeed, it is sometimes sought to locally apply the product to the head of hair in order to obtain in one area a greater effect or in another a lesser effect, and to create for example colored relief effects which, when done carefully, may be attractive. Here too, the user must use tools such as those described above, but it is very difficult to distribute a fluid with a comb while controlling the area in which it will be located. In particular, it is necessary to avoid a lock on which the product has just been applied being able to transfer the product to another area. An approach of the type b) above is rather used, with the addition of protective systems to avoid transfers from area to area. These systems are in the form of strips of paper and are effective. Unfortunately, yet again, the technical know-how and the time required are substantial and, in addition, results are obtained in which the color is highly contrasted, without a continuum between strongly dyed areas and weakly dyed areas. This means there is great difficulty in developing novel effects such as graduated colors or juxtaposed colors, since not only does the application of a color take time, but the application of a second further increases the time required. The same problem exists for other hair dyeing products: lightening and bleaching products.

### SUMMARY

The invention aims to propose a novel hair treatment process for dyeing or bleaching the hair, making it possible to easily dye or bleach the hair and to obtain, if desired, novel dyeing effects.

According to the invention, the process for hair dyeing and/or bleaching comprises the step consisting in applying, to the head of hair, at least one hair dyeing or bleaching compound using a device comprising at least two nozzles, at least one of which is supplied with at least one pressurized liquid containing said compound, the nozzles being arranged such that their respective jets collide with one another.

The axes of the nozzles preferably form an angle of between 30° and 120° with one another. The fact that the jets collide makes it possible to transfer kinetic energy by reducing the size of the drops; this makes it possible to have a resulting stream which is wetting while having low water consumption; it is particularly advantageous to have low water consumption since this facilitates the metering of the products used to treat the head of hair.

The use of such a device to carry out dyeing or bleaching treatments makes it possible to apply the dyeing or bleaching compound(s) without technical know-how or losing time, and to readily obtain a highly homogeneous distribution, if this is desired. It is also possible to arrange the device such that the distribution of the hair product on the head of hair leads to a more intense color effect in certain locations and a weaker one in others, without however producing a contrasted color change.

Moreover, the application does not require touching the hair, which may prove advantageous. It does not require using combs or other tools. Thus, the risk of contamination of the tool in relation to the hairdresser is especially avoided. The invention makes it possible to foam the stream applied and thus to produce a coloring foam on the head. The product may penetrate deeply, up to the roots, and it is easy to treat all the lengths. It is thus possible to carry out dyeing quickly, and there is no need to touch the hair and the product.

It is possible, if desired, to convey the stream dispensed by the device in a localized manner, in order for example to more strongly treat certain locations on the head of hair than others, and to produce color effects such as graduations of color.

It is possible to dispense a single composition onto the head of hair with the device at a given time. It is also possible to produce the device so as to be able to dispense different compositions onto the head of hair, at a given time or offset in time. One variant thus consists in conveying several products separately into a hand piece of the device in order to obtain for example different colors on the head of hair. It is also possible to mix several products to obtain for example a personalized effect.

Other advantages arise at the end of the treatment, since the amount of dyeing product used may be reduced; rinsing can thus be very quick and therefore economical and ecological, and in some cases no traces, or very few traces, of product can be seen during rinsing, and in particular no colored rinsing water can be seen.

The total flow rate sprayed by said nozzles is preferably relatively low, advantageously being between 0.1 and 3 l/min, preferably between 0.2 and 2 l/min, even better still between 0.3 and 1 l/min.

It is possible to vary the supply of the nozzles to bring more or less composition into contact with the head of hair and vary the color result obtained. For example, it is possible to vary the supply pressure of the nozzles to vary the color obtained.

It is possible to apply at least two different dyeing compounds using the device. These compounds may be mixed upstream of the nozzles. As a variant, these compounds are dispensed by specific nozzles, at the same time or not.

The invention applies to the application of any hair dyeing product having a dyeing or bleaching action or enabling the action of a dye.

The abovementioned compound may thus be a dyeing oxidant, an oxidation dye or a direct dye.

The device is preferably arranged to enable dispensing of at least two dyeing products separately. This is advantageous for dyeing operations which require an oxidant such as aqueous hydrogen peroxide and/or those which also use direct dyes, which are mostly incompatible with aqueous hydrogen peroxide and/or the preservatives required by oxidation dyes.

Thus, it possible to produce the device with an inlet of oxidant, an inlet of oxidation dye(s) and an inlet of direct dye(s).

In particular, the oxidant may be aqueous hydrogen peroxide, which is preferentially acidic, the oxidation dye may be a composition, which is preferentially alkaline, with bases such as PPD and other benzene diamine or amine and hydroxyl or dihydroxylated derivatives, heterocyclic derivatives, and the direct dye may contain in particular “cationic” dyes intended to increase the chromaticity of the result.

In one exemplary embodiment of the invention, an oxidizing composition is applied manually to the head of hair then at least one oxidation dye is applied using said device. As a variant, an oxidizing composition is applied using said device then at least one oxidation dye is applied manually.

In one exemplary embodiment:

a) a dyeing compound is applied using the device,

b) the dispensing is stopped and the product is allowed to run by gravity,

c) optional wiping is carried out,

d) steps a) to c) are optionally carried out again with the same compound or a different compound,

e) rinsing with water is optionally carried out.

It is possible to orient the device relative to the head of hair such that the compound dispensed is directed onto the roots of the hair. As a variant, it is possible to orient the device such that the compound is directed to skim the head of hair.

According to another aspect thereof, another subject of the invention is a device for dyeing the head of hair, especially for carrying out the process according to the invention as defined above, comprising:
a hand piece comprising at least two nozzles oriented such that their respective jets collide with one another, the flow rate dispensed being less than or equal to 3 l/min, better still to 2 l/min,
at least one tank containing a dyeing product.

This device may comprise several valves making it possible to selectively dispense at least one compound chosen from several.

The device may comprise several distinct dispensing circuits to dispense different respective dyeing products.

In particular, the device may comprise at least two distinct dispensing circuits making it possible to dispense respective compounds without mixing with one another inside the device. Each dispensing circuit may comprise at least two nozzles to generate jets which collide with one another, and a means for supplying the nozzles under pressure with the desired flow rate. This means may be a pump, for example centrifugal, or a height difference between a source of liquid and the hand piece bearing the nozzles. The nozzles of each dispensing circuit may be arranged side-by-side on the same hand piece. The latter may be fitted with any control interface making it possible to activate this or that dispensing circuit, for example on an on/off basis or with a possibility of setting the pressure and/or the flow rate and/or the concentration of dyeing or bleaching compound.

It is possible to produce the device with at least one circuit for dispensing an oxidation dye, at least one circuit for dispensing a dyeing oxidant, and at least one circuit for dispensing a direct dye.

The device may comprise a set of tanks containing the compound(s) to be dispensed, preferably after dilution in water.

The device may thus comprise a supply of water and means making it possible to inject the compound to be dispensed into a pipe in which the water is circulating.

These means comprise for example a metering pump or a tank connected to the pipe, via a venturi if appropriate. It is further possible to provide that the water circulates through the tank in order to carry along the contents thereof. The latter possibility is especially preferred when the compound is solid, in particular pulverulent. In this case, the compound may be contained in the powder or granule state in the tank which is passed through by the water which reaches the nozzles.

The device may comprise a control system which makes it possible to automate the operation thereof, and especially to control various solenoid valves to dispense one or more compounds according to a chosen sequence; the control system may also control the pressure and the flow rate, for example by acting on the operation of the possible pump(s).

The control system may comprise a microcontroller or any other electronic system making it possible to set parameters for the operation of the device, with a view for example to the chosen result.

The device may comprise any type of man-machine interface making it possible to program it and control the operation thereof.

When the device is intended for dispensing several different dyeing compounds, especially several dyes, it advantageously comprises several tanks containing these dyes arranged in a manner which is visible to the user, for example arranged side-by-side.

The device may be arranged to also make it possible to dispense only water or water with a washing agent added to it, such as a surfactant or a care active ingredient.

### DETAILED DESCRIPTION

The invention may be understood more clearly from reading the following detailed description of non-limiting exemplary embodiments thereof and from studying the appended drawing, in which:

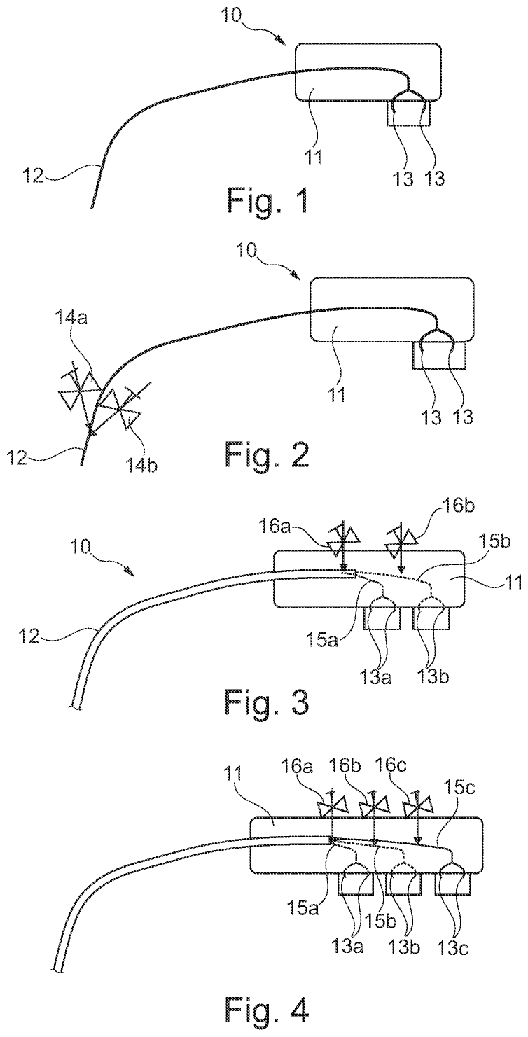

FIG. 1 diagrammatically represents an example of a device for carrying out the process,

FIGS. 2 to 6 are views similar to FIG. 1 of variant embodiments of the device, and

FIG. 7 shows an example of an arrangement of the nozzles within the hand piece.

### DEVICE

The invention is carried out using a dispensing device comprising at least two nozzles arranged such that the respective jets emitted by these nozzles collide with one another and form a resultant stream which is dispensed to the hair. FIG. 1 partially represents such a device 10.

The latter may comprise, as illustrated, a hand piece 11 also termed low-flow shower head, that the user can handle in order to treat the hair, by directing the stream generated by the nozzles onto said hair.

In the example in question, this hand piece 11 is supplied with the composition to be dispensed by at least one hose 12.

The composition is ejected from the hand piece 11 by at least two nozzles 13 which are oriented such that their respective jets collide with one another.

The nozzles 13 are supplied under a relatively high pressure, such that the ejection of the composition, after collision of the jets originating from each nozzle, occurs at significant speed, for example at least 8 m/s.

The composition is pressurized using at least one pump, not shown, or by any other suitable means such as pressurization of a tank containing the composition, or a height difference.

The total flow rate of composition dispensed by the device is preferably between 0.1 and 3 l/min, more preferentially between 0.2 and 2 l/min.

The hand piece 11 may have a cavity 89 open towards the outside, within which the jets emitted by the nozzles 13 encounter one another, as illustrated in FIG. 7. This cavity 89 can diverge towards the outside, with a recess 91 further widening it in proximity to its opening. The cavity 89 can participate in guiding the flow generated after the encounter of the jets in the axis of said cavity, towards the outside.

The speed of the drops, measured at the opening of the cavity 89, in the axis thereof, can be greater than or equal to 8 m/s.

The composition may be obtained by injecting, into a pipe in which water is circulating, a hair dyeing product such as a dye.

The pressure upstream of nozzles 13 is for example between 4 and 25 bar.

The nozzles may be simple orifices, the diameter of which is chosen to obtain the desired ejection speed.

The diameter of these orifices is for example between 0.1 and 2 mm.

The device 10 may comprise any system for controlling the dispensing and the flow rate.

For example, the device 10 comprises, at the hand piece 11, a member (not visible) for controlling a valve (not shown), on which the user can press to supply or not supply the nozzles 13 with the pressurized composition.

This control member may act mechanically on a valve present on the hand piece. As a variant, the control member is a switch which controls a solenoid valve and/or the operation of a pump which serves to pressurize the composition upstream of the nozzles. When a dyeing product is injected from a tank into a pipe that conveys it to the nozzles, this injection may be carried out in a metered and/or controlled manner.

For example, the injection is carried out via a proportional solenoid valve, the opening of which is regulated by a control system as a function, for example, of the concentration of dyeing product it is sought to obtain at the outlet of the nozzles 13. The device 10 may comprise a man-machine interface which enables the user to control the concentration of dye in the stream dispensed by the nozzles 13.

As a variant, the dye is injected in pulses, with a frequency and/or a duty cycle chosen as a function of the desired concentration.

The device may comprise a control system making it possible to vary the concentration of dyeing product over time, as a function of the desired result.

The device may comprise a control system making it possible to act on the flow rate of the stream dispensed by the hand piece, on the concentration of dyeing product within the dispensed liquid, on the length of time for which the stream is dispensed, and/or on the pressure upstream of the nozzles. All these parameters may be able to be regulated, depending on the exemplary embodiments, continuously or incrementally, manually or in a way which can be controlled electronically.

The control system may be arranged to be able to assume at least two operating modes, namely a first mode in which the device dispenses a dyeing product, and a second washing mode in which the device dispenses water alone or water with at least one care active ingredient or a washing agent such as a surfactant.

The system may be arranged to be able to assume at least three operating modes, namely a washing mode in which the device dispenses water with, where appropriate, at least one surfactant added thereto, a dyeing or bleaching mode in which the device dispenses at least one dyeing product, and a rinsing mode in which the device dispenses water and, where appropriate, at least one active ingredient to aid rinsing.

The control system may be arranged to make it possible to simultaneously or successively dispense several different products.

In the example of FIG. 1, the nozzles 13 are supplied by the same pipe and dispense the same composition.

In a variant, the nozzles 13 are supplied by different pipes and can dispense different compositions which mix together when the jets meet. Different products may also be injected upstream of the hand piece 13, into the same pipe 12, the injection of one product taking place without the injection of the other, or the injections being able to take place at the same time to mix the products.

The solenoid valve(s) or other means making it possible to control the intake of the dyeing product(s) and also, if appropriate, the flow rate of the stream dispensed by the device, may be integrated into the hand piece 11 or be present within the device 10 upstream of the hand piece, as illustrated in FIG. 2.

This figure diagrammatically shows two valves 14a and 14b, preferably solenoid valves, making it possible to regulate the intake, into the pipe leading to the nozzles 13, of two different dyeing products, in order for example to vary the color result obtained. FIG. 3 shows the possibility of having specific dispensing circuits for two compositions liable to be dispensed by the device on the hand piece, namely a first circuit 15a and a second circuit 15b.

Each circuit 15a or 15b comprises a specific pipe connected to its own set of nozzles 13a or 13b. The nozzles 13a generate jets which collide with one another, just like those of the nozzles 13b.

The pipes of the circuits 15a and 15b may comprise ducts grouped together within the same hose 12, as illustrated.

The device may comprise means for controlling each circuit 15a or 15b, in order to make it possible to dispense two respective compositions via these two circuits, this dispensing being able to be carried out successively or simultaneously, for example.

Each circuit may comprise a valve for regulating the intake into said circuit of a corresponding dyeing product. Each circuit may comprise its own pressurizing pump, where appropriate.

FIG. 3 shows the possibility of regulating, using valves 16a and 16b, preferably solenoid valves, independently at the hand piece, the flow rate and/or the concentration of product of the stream dispensed by each circuit.

The nozzles 13a and 13b are preferably close together, so as to keep a certain degree of compactness for the hand piece.

FIG. 4 shows the possibility for the device 10 to dispense several dyeing products by means of three distinct dispensing circuits 15a to 15c, having respective sets of nozzles 13a, 13b and 13c.

The hand piece 11 receives a supply of water. Means make it possible to control the injection of the different dyeing products into the water.

In the example in question, the circuit 15a is dedicated to dispensing a dyeing oxidant onto the head of hair, such as aqueous hydrogen peroxide, the circuit 15b is dedicated to dispensing an oxidation dye, and the circuit 15c is dedicated to dispensing a direct dye.

Valves 16a to 16c, preferably solenoid valves, make it possible to independently regulate the flow rate and/or the concentration of product of the stream dispensed by each circuit 15a to 15c.

In the example of FIG. 4, these valves 16a to 16c are integrated into the hand piece 11.

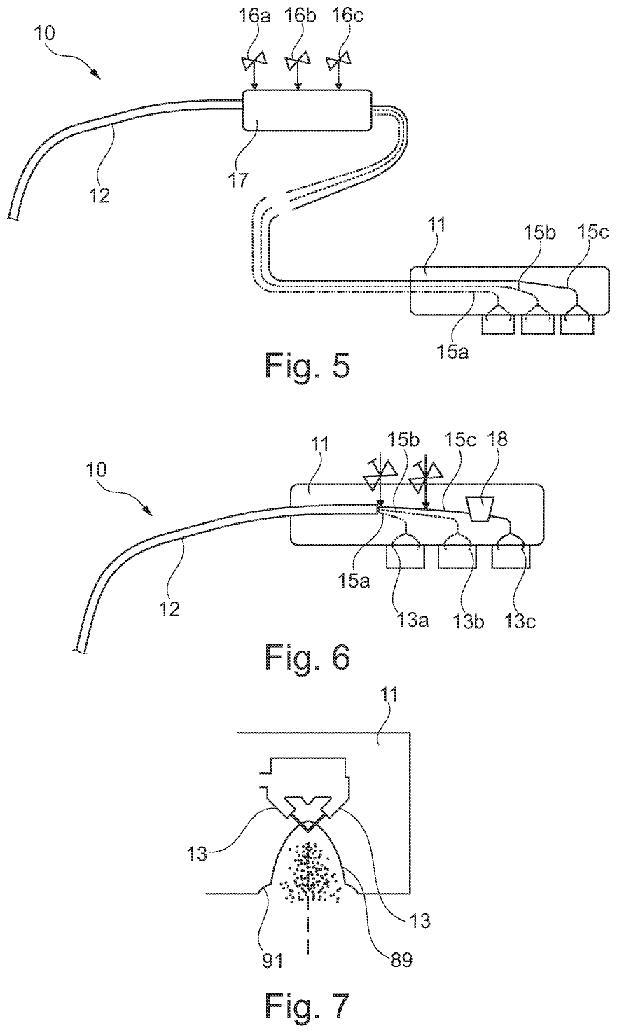

In the variant of FIG. 5, they are arranged upstream of the hand piece, at a control block 17.

The device 10 may be provided to operate with dyeing products introduced in a liquid form into the device, for example in a concentrated form.

The device 10 may further be configured to be able to operate with at least one dyeing product initially present in a solid form, especially in the form of a powder.

For example, the hand piece 11 comprises a tank 18, as illustrated in FIG. 6, which can be filled with an amount of powder intended for one use, then re-closed. In the example in question, this tank 18 is integrated into a dispensing circuit 15c, supplied with pressurized water and connected to nozzles 13c. When the water circulates in the circuit 15c, the powder dissolves on contact with the water circulating in the tank 18 and becomes incorporated in the dispensed stream.

This possibility is especially advantageous for bleaching which may require, for strong effects, persulfate powders.

An especially advantageous assembly lies, as illustrated in FIG. 6, in the combination, within the device 10, of a dispensing circuit 15c comprising at least one tank of persulfate powder(s) and/or at least one alkaline agent, of a dispensing circuit 15b for dispensing a liquid alkaline agent, and of a dispensing circuit 15a for dispensing a liquid oxidant such as aqueous hydrogen peroxide.

Other combinations are possible, such as a dispensing circuit having a tank of powdered oxidant, such as a persulfate, and at least one dye, whether oxidation dye or direct dye.

The advantage associated with the presence of several respective dispensing circuits is that of not bringing the powder(s) or other compound(s) into contact with the other ingredients and thereby avoiding incompatibilities.

The dyeing product(s) may be received in tanks which are visible to the user, in order to form for example a dye “bar”. These tanks may have a transparent wall, where appropriate, in order to enable people to see the contents thereof, especially the color. These tanks may constitute interchangeable cartridges.

The device 10 according to the invention may be controlled by the hairdresser or by a predefined program or an expert system capable of analyzing the situation to activate the different valves or pumps with a view to dispensing a product under the desired conditions.

Thus, the device may comprise a system having a processor which runs a program making it possible to select products or mixtures of products which will be conveyed in the stream and at what times, helping the hairdresser to obtain the result which most pleases their client and/or to obtain novel effects. The system may be arranged to store a setting or a sequence in memory in order to reproduce it on the same client or another one.

The device may combine a dyeing function and other functions, such as typically washing (using surfactants) or care (using oily or cationic compounds, for example).

The top of the hand piece, which bears the nozzles, can be coupled to a guard, making it possible to prevent splashing.

Use may be made of hot water as supply water, in order to improve the comfort of the person being treated and to induce a possible activation.

As has just been seen, the dyeing may be personalized in terms of coloring strength via controllable valves and/or the choice of the pressure. The hairdresser may thus dispense at least one dyeing product so as to obtain several levels of coloring strength, in particular by generating more or less treating stream on the head of hair or, preferably, by regulating the introduction of the dyeing product(s) into the stream.

The dyeing may be personalized in terms of choice of colors. Thus, via controllable valves, the hairdresser can dispense a dye which will be the addition of several products.

He or she may then carry out homogeneous or non-homogeneous application. This solution has the advantage of simplifying the hairdresser's work.

It is especially possible, as has just been seen:

a. either to provide a set of valves which control the intake of several products before a common introduction into the stream;

b. or to provide a device with several outlets, which are preferably adjacent; in addition to being much more simple than mixing several products in a bowl, the advantage of this solution is that it avoids problems of mixing and possible incompatibility between products, and of needing to flush out. Indeed, if desired, it is possible to not mix the products and to convey several streams which mix together after leaving the nozzles.

Dyeing Product

“Dyeing product” should be understood as any product of use for changing the color of the head of hair, especially in a lasting manner. This may be an oxidation dye, a direct dye or a dyeing oxidant.

The oxidation dye may be chosen from one or more oxidation bases optionally combined with one or more coupling agents.

By way of example, the oxidation bases are chosen from para-phenylenediamines, bis(phenyl)alkylenediamines, para-aminophenols, ortho-aminophenols and the corresponding addition salts.

By way of example, the coupling agents are chosen from meta-phenylenediamines, meta-aminophenols, meta-diphenols, naphthalene-based coupling agents and also the corresponding addition salts.

The dyeing oxidant may be chosen from hydrogen peroxide; urea peroxide; alkali metal ferricyanides or bromates; peroxygenated salts such as, for example, persulfates, perborates and percarbonates of alkali metals or alkaline earth metals, such as sodium, potassium and magnesium; or mixtures thereof.

The direct dye may be chosen from azo direct dyes; (poly)methine dyes such as cyanines, hemicyanines and styryls; carbonyl dyes; azine dyes; nitro(hetero)aryl dyes; tri(hetero)arylmethane dyes; porphyrin dyes; phthalocyanine dyes and natural direct dyes, alone or in the form of mixtures.

The content of dyeing product in the stream dispensed by the hand piece is for example between 0.01 and 99% by weight relative to the total weight of the stream, better still between 0.1 and 90%.

For a dyeing product constituted by a dyeing oxidant, the concentration by weight of dyeing oxidant in the product is for example between 0 and 99%, better still between 10 and 80%.

For a dyeing product constituted by an oxidation dye, the concentration by weight of dye in the dyeing product is for example between 0.1 and 50%, better still between 1 and 30%.

For a dyeing product constituted by a dyeing oxidant, the concentration by weight of dyeing oxidant in the stream is for example between 0 and 40%, better still between 1 and 10%.

For a dyeing product constituted by an oxidation dye, the concentration by weight of dye in the stream is for example between 0.01 and 10%, better still between 0.1 and 3%.

For a dyeing product constituted by a direct dye, the concentration by weight of dye in the dyeing product which is injected into the water is for example between 0.1 and 50%, better still between 0.2 and 30%.

For a dyeing product constituted by a direct dye, the concentration by weight of dye in the stream is for example between 0.01 and 10%, better still between 0.1 and 3%.

Exemplary Embodiments

In one embodiment of the invention, the hairdresser carries out the whole operation at the basin. Thus, the client does not take up space in front of the mirrors during the leave-on time, since they remain at the basin. This minimizes back-and-forth movements within the salon.

In another embodiment, the hairdresser applies at the basin, using the device, then asks their client to wait in an area of the salon such as a chair, or standing up. Thus, the client does not take up space in front of the mirrors or at the basin. This maximizes the salon's work stations.

The hairdresser may further apply at the basin using the device, then allow their client to leave as soon as the application is finished. Once the client has returned home, he or she can then finish their treatment by simple rinsing.

In another embodiment, an oxidizing composition is applied by hand or in some other way, then the device according to the invention is used to convey at least one dye.

In another embodiment, the hairdresser applies, to the temples or any other chosen area, an oxidizing composition, for example aqueous hydrogen peroxide, then uses the device for a global application of a dyeing composition, for example a composition providing black. Only the areas of the head of hair that received the oxidant in a localized manner will be dyed; for example, in the case of an application of aqueous hydrogen peroxide that is limited to gray temples, only the latter will be concealed.

It is further possible, according to a variant embodiment, to apply a dyeing composition via the device, then to apply bleaching by any other means.

It is possible to couple the process according to the invention to other hairdressing procedures. In particular, it is possible to apply heat or a stream of hot or cold air in order to accelerate drying, thus making it possible for the person to leave the salon.

Examples of Application Techniques

Homogeneous Application

It is possible to apply a dyeing product using the device according to the invention to dry or wet hair. The device can be started up in a mode in which it injects the dyeing product directly into the stream. Thus, the stream encounters dry hair, which increases absorption and thus penetration. The rate of injection may range from 1% to 100% and more preferentially from 2% to 40% (by weight of injected product relative to the weight of water into which the product is injected). Approximately 3 to 20 seconds are required to treat the head of hair. During the application, the stream is inserted between the hairs, producing an effect of separating the hairs and therefore good infiltration of the formula at all areas of the head of hair, even at the roots.

After stopping, it is possible to wait for a few tens of seconds. The surplus tends to be eliminated naturally by gravity within less than a minute. Optionally, it is possible to wipe areas which should not have been covered.

It is then sufficient to wait for a few minutes to a few tens of minutes. It is then possible, depending on the desired result, to:
rinse, or
dry, or
rinse then dry, or
dry then rinse, or
dry then rinse then thy.

Heterogeneous Application

Method 1

The application may be performed on dry or wet hair.

The device is started up in a mode in which it dispenses the dyeing product. Certain areas are targeted.

The device is stopped. The surplus tends to be eliminated naturally by gravity within less than a minute.

Optionally, it is possible to wipe certain areas.

This method is especially advantageous for creating multicolored effects.

Method 2

Following the application of a dyeing product homogeneously or heterogeneously according to method 1 above, the device is started up in a mode in which it dispenses the same product or another dyeing product. Certain areas are targeted. The device is stopped. The surplus is eliminated naturally by gravity within less than a minute. Optionally, it is possible to wipe certain areas.

This method is especially advantageous for creating contrast effects. For example, a coppery dye is applied according to the homogeneous application method, then, according to the heterogeneous application method 2, a red dye composition is applied only in certain locations.

Method 3

The application may be performed on dry or wet hair.

The device is started up in a mode in which it dispenses a dyeing compound, using the hand piece such that the outlet end thereof is close to the scalp.

The device is stopped. The surplus is eliminated naturally by gravity within less than a minute. Optionally, it is possible to wipe certain areas. This method is especially advantageous for treating roots.

Method 4

The application may be performed on dry or wet hair.

The device is started up in a mode in which it dispenses the dyeing compound using the hand piece such that the stream emitted skims (i.e. is tangential to) the head of hair.

The device is stopped. The surplus is eliminated naturally by gravity within less than a minute. Optionally, it is possible to wipe certain areas.

This method is especially advantageous for creating graduated color effects and for reviving the lengths, which is especially beneficial for long and/or damaged hair.

The table below sums up some advantages and effects of these various exemplary embodiments.

| | Advantages | Application |
|---|---|---|
| Homogeneous | Enables a | Highlights |
| application | homogeneous and very quick | Color reactivation |
| | result | First color |
| | | Others |
| Heterogeneous | Enables a result | Attractive |
| application - method 1 | with shades of strength of | monochromatic effects |
| | effect, without technical | |
| | know-how nor loss of time | |
| Heterogeneous | Enables a result | Attractive |
| application - method 2 | with several shades, without | bichromatic or polychromatic |
| | technical know-how nor loss | effects |
| | of time | |
| Heterogeneous | Enables a special | Treatment of the |
| application - method 3 | root result, without technical | roots to compensate for |
| | know-how nor loss of time | regrowth |
| Heterogeneous | Enables a special | Treatment of the |
| application - method 4 | length result, without | lengths to compensate for losses |
| | technical know-how nor loss | along the lengths + obtaining |
| | of time | graduated effects |

The various procedures may be combined, for example for treating the roots to compensate for regrowth and give a new color to the lengths.

Some examples of treatments will now be described.

### EXAMPLE 1

A device according to the invention was used with a total flow rate of 2 l/min. The supply pressure of the nozzles is 16 bar, the speed of the stream after collision of the jets is 8 m/s, the diameter of the nozzles is 1 mm and the angle of the nozzles is 45°.

The dye Preference Infinia Shade 1 Napoli was mixed with a permanent-wave fixing agent Dulcia 8 V. The mix is 1:2 (formulation A).

The device is arranged to inject this formulation A into the water in order to obtain a concentration at 8% by weight in the water.

In order to carry out the test, a supply of hot water (40° C.) was used.

A half head of hair was targeted (30 cm long, Caucasian, light brown) for 10 seconds. A foam formed on the half head of hair treated.

This was then left to rest.

No color was observed in the rinsing water during rinsing.

It was also observed that the hair was dyed entirely visibly and homogeneously. The hairdressing time was 20 seconds (application and rinsing), and it is considered that the device saved the hairdresser more than 10 minutes.

### EXAMPLE 2

A formulation B was produced with a Hi-Chroma cationic dye at 4% by weight in water (spontaneous pH).

The same assembly was used as in example 1, except for the fact that two dispensing circuits identical to that of example 1 are combined, namely one for the oxidation dye and one for the Hi-Chroma cationic dye. Each has a pump and a supply of water. A control system makes it possible to actuate the injection of the two products separately or together.

A first method consisted in applying the two products in two stages, starting with the oxidation dye (as in example 1) then, after about ten seconds, continuing with the Hi-Chroma cationic dye. Then, after stopping and after 10 minutes, final rinsing was carried out, followed by drying. The color result was chromatic.

A second method consisted in applying the two products in the same operation. The user initiated the intake of the oxidation dye and actuated, intermittently, the Hi-Chroma cationic dye. Then, after stopping and waiting for 10 minutes, final rinsing was carried out, followed by drying. The color result was chromatic and contrasted.

### EXAMPLE 3

A formulation C was prepared, equivalent to the formulation A of example 1 except for the fact that no aqueous hydrogen peroxide was introduced, the latter being replaced by a composition of lauryl ether sulfate (LES) at 10% by weight in the water.

A Recital Clear dye (without oxidation dyes) was then applied by hand to the lengths of the hair. After 10 minutes, the device according to the invention was used to apply the formulation C globally. An abundant foam was obtained in this way. After rinsing, only the lengths are dyed.

### EXAMPLE 4

A formulation D was produced, equivalent to the formulation A except for the fact that the 8V oxidant was replaced with 30V oxidant.

The same assembly was used as in example 1, except for the fact that two dispensing circuits are combined, namely one for the formulation A and the other for the formulation D.

A control system makes it possible to actuate the injection of the two products separately or together.

During the application, the user modulates the arrival of the two dyeing products depending on the areas. After leaving on (20 minutes) then rinsing and drying, a contrasted color result can be observed.

### EXAMPLE 5

A formulation E was produced with a base/coupling agent mixture of 1% para-phenylenediamine and 1% resorcinol in water and aqueous ammonia (q.s. for pH 11) and mixed 1:1 with the 30V oxidant.

The same assembly was used as in example 1, except for the fact that two dispensing circuits are combined, namely one for the formulation A and the other for the formulation E. A control system makes it possible to actuate the dispensing of the two products separately or together.

During the application, the hairdresser modulates the arrival of the two dyeing products depending on the areas. After leaving on (5 minutes) then rinsing and drying, a contrasted color result with coppery areas and brown areas can be seen.

1. A process for hair dyeing and/or bleaching, comprising the step consisting in applying, to the head of hair, at least one hair dyeing or bleaching compound using a device comprising at least two nozzles, at least one of which is supplied with at least one pressurized liquid containing said compound, the nozzles being arranged such that their respective jets collide with one another, the liquid containing the composition being ejected at a speed of at least 8 m/s.

2. The process as claimed in claim 1, a total flow rate sprayed by said nozzles being between 0.1 and 3 l/min.

3. The process as claimed in claim 1, wherein supply of the nozzles is varied in order to vary the result obtained.

4. The process as claimed in claim 1, wherein supply pressure of the nozzles is varied in order to vary a resulting color obtained.

5. The process as claimed in claim 1, wherein at least two different dyeing products are applied using the device.

6. The process as claimed in claim 5, the products being mixed upstream of the nozzles.

7. The process as claimed in claim 5, the products being dispensed by specific nozzles.

8. The process as claimed in claim 1, said compound is dyeing oxidant.

9. The process as claimed in claim 1, said compound is an oxidation dye.

10. The process as claimed in claim 1, said compound is direct dye.

11. The process as claimed in claim 1, wherein an oxidizing composition is applied manually to the head of hair, then at least one oxidation dye is applied using said device, or an oxidizing composition is applied using said device then at least one oxidation dye is applied manually.

12. The process as claimed in claim 1, wherein:
a. a dyeing compound is applied using the device,
b. the dispensing is stopped and the product is allowed to run by gravity,
c. optional wiping is carried out,
d. steps a) to c) are optionally carried out again with the same compound or a different compound,
e. rinsing with water is optionally carried out.

13. The process as claimed in claim 1, wherein the nozzles are oriented relative to the hair such that the compound is directed onto the roots of the hair.

14. The process as claimed in claim 1, wherein the nozzles are oriented such that the compound is directed to skim the head of hair.

15. A device for dyeing the head of hair:
a hand piece comprising at least two nozzles oriented such that their respective jets collide with one another, the flow rate being less than or equal to 2 l/min, the liquid being ejected at a speed of at least 8 m/s,
at least one tank containing a dyeing compound.

16. The device as claimed in claim 15, further comprising several valves configured to selectively dispense at least one compound chosen from several.

17. The device as claimed in claim 15, comprising several distinct dispensing circuits to dispense different respective dyeing products.
